(19) United States
(12) Patent Application Publication
(10) Pub. No.: US 2007/0032945 A1
(43) Pub. Date: Feb. 8, 2007

(54) System and method for providing location related information to a network user

(76) Inventor: Jason Kaufman, New York, NY (US)

Correspondence Address: KENYON & KENYON LLP, ONE BROADWAY, NEW YORK, NY, 10004, US

(21) Appl. No.: 11/195,984

(22) Filed: Aug. 2, 2005

(51) Int. Cl. G01C 21/30

(52) U.S. Cl. 701/208; 701/207; 340/995.1

(57) ABSTRACT

In a system and method for providing location related information to a network user, a processor may generate for display at the user's device an interactive map having embedded therein selectable objects, including objects for representing a location of other logged in network users.

### BACKGROUND

In a computer network environment, it is conventional to inform a network user of a connection status of other users. Such information may enable a user to interact, e.g., in real-time, via the network with other network users without requiring the user to repeatedly attempt to contact non-connected users.

A user often seeks to communicate, e.g., via the network, with other users to share in an experience together or to arrange an in-person meeting with the other users. In these and other instances, it is often desirable for the user to communicate with users who are in a particular location. Accordingly, in addition to informing the user of the conventionally provided connection status of other users, it may be desirable to provide to the user location-related information of the other users.

Additionally, the particular users with whom the user may choose to communicate often depends on the structures, events, facilities, etc., that are located or that are held at a location at or near the particular users. For example, for a user searching for a particular item sold at only particular stores, it may be advantageous to communicate with particular users who are at a location near such particular stores. Accordingly, it may be desirable to provide to the user information concerning the nature of the geographic locations at which other network users are located.

Aside from geographically related information associated with other network users, it may be desirable to provide to the user information concerning the nature of the geographic location at which the user is located. For example, it may be desirable to indicate to the user that the user is at a location near the particular stores at which the particular item is sold.

### BRIEF DESCRIPTION OF THE DRAWINGS

FIG. 1 is a block diagram that illustrates components of an example system, according to an example embodiment of the present invention.

FIG. 2 is a flowchart that illustrates an example procedure which may be executed to provide an interactive map, according to an example embodiment of the present invention.

FIG. 3 is an example map provided according to an example embodiment of the present invention.

FIG. 4 illustrates example maps that may be alternatively provided using a zooming capability provided in an example embodiment of the present invention.

FIG. 5 illustrates an example map that may be generated by an event and/or location specific program, according to an example embodiment of the present invention.

### DETAILED DESCRIPTION

Since communications, meetings, experiences, etc., e.g., their content or desirability, often bear a relationship to a location, it may be desirable to inform a network user of locations of other network users and to provide the network user with information regarding said locations and regarding a location of the network user.

Embodiments of the present invention relate to a system and method for providing a network user with location related information regarding locations of other network users and regarding the network user's location, and more particularly, for visually providing said information with reference to an electronic map. Embodiments of the present invention further relate to a system and method for informing a network user of a connection status of other network users via a visual representation of their connectivity with reference to an electronic map. Embodiments of the present invention further relate to a system and method for providing a location or event related program, which, when executed, provides an electronic map of the location or of a location associated with the event, wherein said map includes location or event related objects with which a network user may interact.

### Overview of Example System

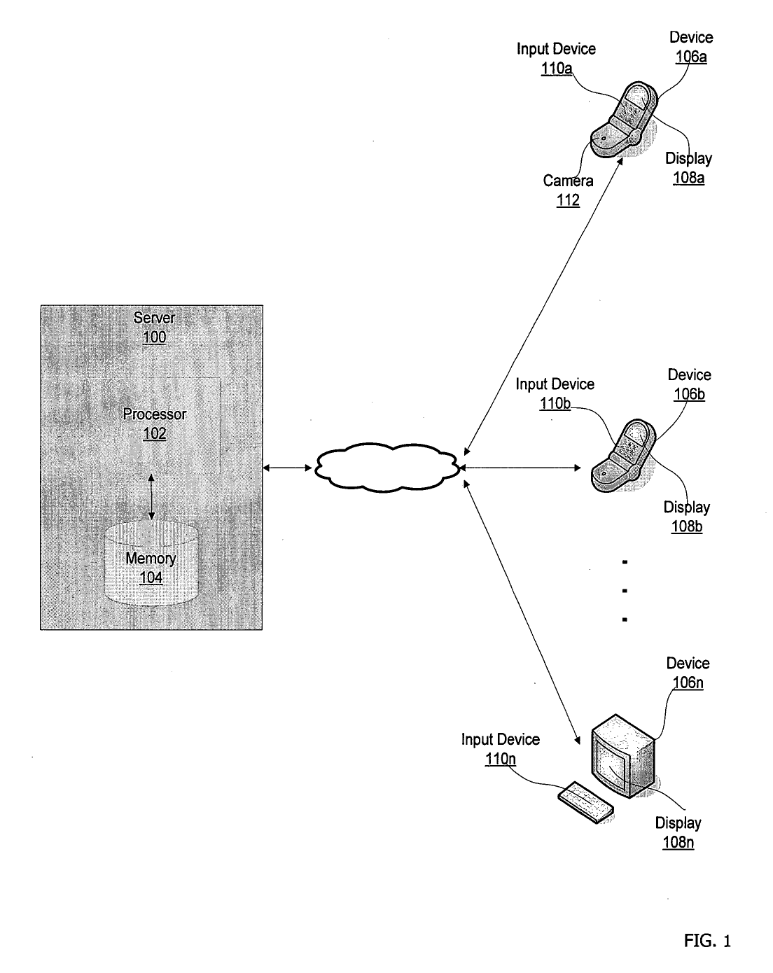

FIG. 1 illustrates an example system according to an example embodiment of the present invention. In an embodiment of the present invention, a central network server 100 may be provided. The server 100 may include a processor 102 and a memory 104. The processor 102 may receive data from network users. Such data may include, e.g., log-in data, requests, and message postings. Users may access the server 100 via devices 106a-n. The devices 106 may be, e.g., computer terminals, telephones, cell phones, pagers, pocket PCs, tablet PCs, laptops, Global Positioning System (GPS) devices, or any other conventional data transmitter and/or receiver devices. One or more of the devices 106 may include a display 108. In response to a request by a user via a device 106, the server 100 may transmit data to the device 106 for providing content in a graphical user interface at the display 108 of the device 106. For example, using an input device 110, the user may enter a Uniform Resource Locator (URL), number, or e-mail address that is associated with the server 100. In response thereto, the server 100 may provide the content for display at the device 106. In one embodiment the input device 110 may be integrally formed with or connected to the device 106. Alternatively, the input device 110 may be provided separately. According to this alternative, the user may include in the data request an identification of the device 106 at which the server provided content is to be displayed. Alternatively, the processor 102 may retrieve from the memory 104 a stored identification of one or more devices 106 associated with the requesting user at which to display the server provided content. The input device 110 may be, e.g., a keyboard, key pad, scroller, mouse, or any other conventional input device.

In an embodiment of the present invention, a software programmer, a server operator, and/or network users may input location related data. Such data may be incrementally input. Location related data may include, e.g., latitude and longitude information, a picture, a country name, a state name, a city name, a street name, a name of a facility, a region type, such as residential or commercial, etc. The processor 102 may store the location related data in the memory 104. The processor 102 may retrieve the location related data from the memory 104, and based on the retrieved data, may generate an electronic map. The electronic map may be provided as content for display at a device 106.

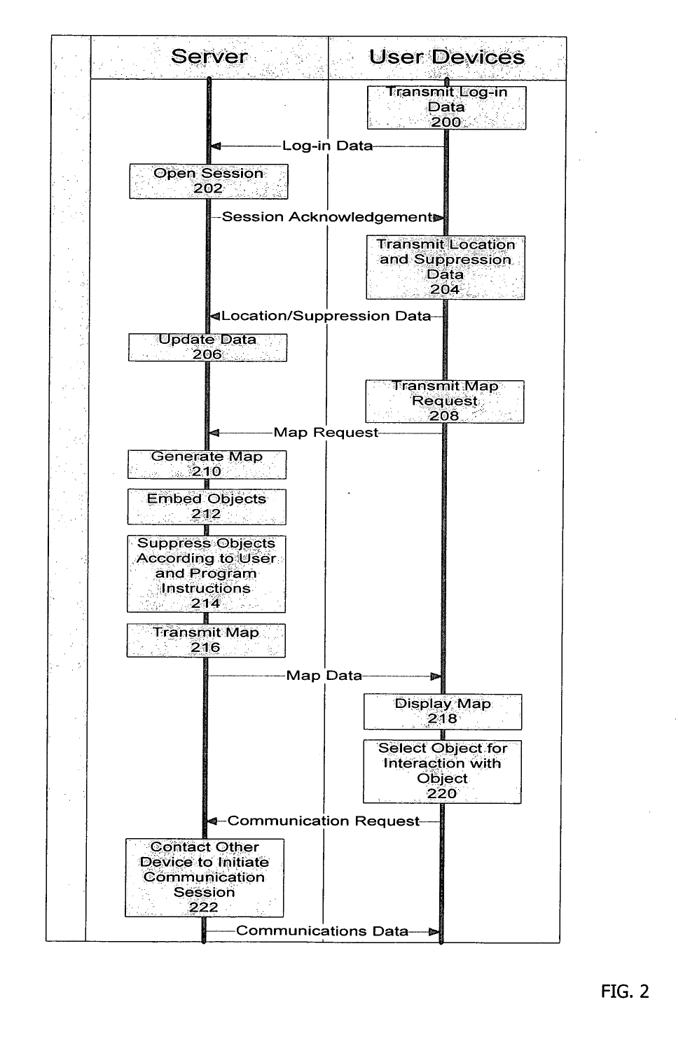

FIG. 2 illustrates an example procedure that may be executed for providing a map to one or more users in an example embodiment of the present invention. Users may access a server via user devices. At 200, a user may transmit log-in data to the server. The log-in data may include location related data, such as a location of the user. At 202, upon receiving the log-in data, the server may open a network session for the user. Upon opening the session, the server may transmit a session acknowledgement to the user. For example, the session acknowledgement may be data for displaying at the user's device a network session page via which the user may interact with the network. In addition to or instead of transmitting location related information to the server at 200, the user may transmit location related data during the session at 204. Such location related data may include an identification of a location of the user, e.g., a location update, and/or may include information about a location or messages associated with a location. At 204, the user may additionally transmit object suppression data that includes instructions regarding which objects to suppress when transmitting a map to the user and/or to other users. 204 may be repeated numerous times during a network session. In response to receipt of said location and suppression data, the server, at 206, may update stored data to reflect the received location and suppression data.

At 208, a user may transmit to the server a request for an interactive map. Although 204 and 208 are separately shown, they may be performed at the same time. For example, the user may select particular display options that indicate suppression preferences and may then select a displayed button for transmitting a map request formulated in accordance with the selected display options. At 210, in response to the map request, the server 210 may generate a map for display at the user device of the requesting user. At 212, the server may embed location related objects at a number of locations in the map. The server may determine which objects to embed based on stored location related data. For example, the particular objects to embed and the particular placement of such objects may be in accordance with data updates performed at 206 in response to receipt of location data from the requesting and/or other users. For example, the server may embed an object corresponding to each of a plurality of users that are logged in to the network and who have indicated their locations. At 214, the server may suppress particular embedded objects from display at the device of the map requesting user according to stored suppression instructions. These instructions may include instructions provided by the requesting user, by other users, and/or by pre-programmed settings as will be discussed in detail below. At 216, the server may transmit the map to the requesting user's device. At 218, the user may receive at the user's device the map data and may display the map according to the transmitted map data.

The displayed map may include selectable objects. At 220, a first user may select an object to interact with that which is represented by the object. For example, if the object represents another network user, selection of the object may be to request a communication session for communicating with the other network user. Selection of the object may cause a communication session request to be transmitted to the server. In response to the communication session request, at 222, the server may contact a device that corresponds to the other network user in order to initiate a communication session between the two users. The server may transmit to the device of the other network user communications data, e.g., that includes data indicating an attempt to establish a communication with the device of the other network user, content transmitted by the first user, and/or an identification of the second user.

### Electronic Map

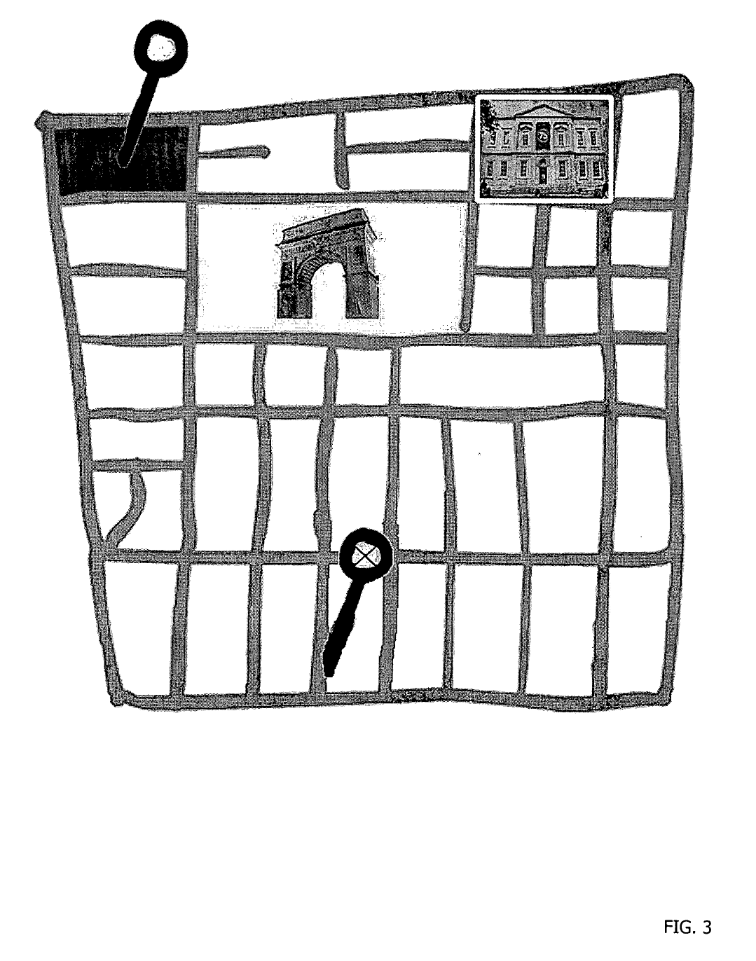

FIG. 3 illustrates an example map provided for display at a device 106, according to an example embodiment of the present invention. The processor 102 may generate a map that includes a plurality of objects. Such objects may include, e.g., geometrical shapes representing a network of roads or paths, and/or shapes that represent structures, network users, message postings, image postings, and/or events. For example, the paths may include a train path such as a subway system, a bus path, a plane path, a path of a marathon, etc. The structures may include for example, a stadium, office building, museum, mall, a fire hydrant, a subway grate, etc. Message postings may be messages input by users via an input device 110. The user may indicate to the processor 102 that the message and/or image is associated with a particular location or location type, e.g., with all malls. In response to receiving such input, the processor 102 may embed in the electronic map an object representing the message posting and/or image posting. The object may be embedded at a location or at locations in the map corresponding to the location or location type indicated by the user. Alternatively, if the user posting the message and/or image indicates to the processor 102 where the user is located, the processor may embed the object representing the message at the location of the user. The user may provide metadata describing a posting, e.g., a time when an image was taken or when content of a message was composed, a camera angle or type, etc. The metadata may be stored by the processor 102 in the memory 104. In one embodiment, the metadata may be used by the processor 102 for sorting the data, e.g., according to a timeline representing times at which images were taken or posted. In one embodiment, the metadata may be displayed, e.g., as part of the object corresponding to the posted message or image, or as separate objects associated with the objects corresponding to the posted message or image. In response to input by a user, the processor 102 may embed corresponding objects in maps provided to other users. The processor 102 may display a particular map at user devices 106 of a plurality of user, such that each map display is different, depending on user preferences, as will be discussed in detail below.

In an embodiment of the present invention, the processor 102 may embed various object types, e.g., icons, depending on that which the objects represent. For example, the processor 102 may embed a pin object, as shown in FIG. 3, and/or a call-out object (not shown) to represent a posted message. The processor 102 may embed a pin or other object to represent a network user's presence at a particular location. To differentiate between two pin types, the processor 102 may display the pins, e.g., having different colors. The processor 102 may embed a picture of a structure for representing structures or particular structure types. For example, the picture of a structure embedded in the map illustrated in FIG. 3 may represent a museum. In one embodiment, a picture of a particular structure may be uploaded to the server 100. The processor 102 may embed the picture at a location in the map corresponding to an actual location of the particular structure. In one embodiment, the processor 102 may embed a generic structure object to represent a structure by default, unless a picture of the structure is uploaded. To limit the amount of data to be transmitted for displaying the map, some structure types may be indicated by generic icons regardless of whether the processor 102 has access to a picture of the object. For example, for a display of fire hydrants and/or subway grates, the processor 102 may provide data that indicates that a same generic fire hydrant and/or subway grate is to be displayed at a number of locations in the map. For a user to differentiate between object types, the processor 102 may provide the user with a map legend.

### User Associated Map Objects

In an embodiment of the present invention, network users may be assigned unique identifiers, such as a username, e.g., selected by the processor 102 or by the users. At any device 106, a user may log into the network using the username. In response, the processor 102 may open a network session for the user. The processor 102 may associate each session with a particular network address or particular device 106, e.g., the device at which the user logged in or another device as indicated by the user. For each username, the processor 102 may embed an object in the electronic map. The map location at which the processor 102 embeds the object may correspond to a real space location of the user at the time the user logs into the network with the user's associated username. In one embodiment, the processor 102 may continuously update the map during the user's session to reflect the user's movements. For example, the processor 102 may update the map in response to each movement detected by the processor 102 or at predetermined time intervals.

In one embodiment of the present invention, trail objects may be provided for each user or username. The processor 102 may record all of a user's locations over time and may record, for each of the locations, the time at which the user was at the location or the time at which the processor 102 was informed of the location. The processor 102 may generate a trail object corresponding to the sequence of the user's locations and movements over time. In one embodiment, the trails may be sortable. For example, a user may enter time intervals, and the processor 102 may generate a trail for the user, for a different identified user, or for each of a plurality of users, showing the user's or users' movements during the specified time interval. Such trails may be useful to determine whether and when particular users crossed paths.

In one embodiment of the present invention, the processor 102 may determine a user's location according to location input provided by the user via an input device 110. For example, at log in, the server 100 may provide to the user a log-in page that includes a plurality of fields of which one is for entering a location, e.g., identified by street name, latitude/longitude, or in any other conventional manner by which to identify a location. In one embodiment, the server 100 may provide a map. The processor 102 may determine the location in response to a selection in the map of a particular location, e.g., by point and click. Alternatively, the user may provide location information by transmitting an image generated by a camera 112, e.g., a still frame or video camera. The processor 102 may determine the user's location by matching the image to an image stored in the memory 104. For example, an image of a sidewalk may be matched to a stored image of a sidewalk in accordance with a unique pattern of the sidewalk. A sidewalk's pattern may be unique with respect to, e.g., cracks, crevices, embedded objects, coloring, gumspots, etc. Alternatively, or in addition, the image may be of particular structures at the user's location.

According to the embodiment in which the processor 102 continuously updates the location of the object to reflect changes in the user's location, the user may repeatedly transmit updated location information during the session. For example, the user may press a direction key, move a scroller, or drag an object, e.g., the object corresponding to the user, through the electronic map to a new location.

In an embodiment of the present invention, the processor 102 may require a user to provide the user's location at log-in. Alternatively, the processor 102 may place the object corresponding to the user's username at a location in the map that corresponds to a last known location stored in the memory 104. If the memory 104 does not include location information associated with the username, an object corresponding to the username may be omitted from the map, or may be placed, e.g., at a part of a display area that does not include the electronic map or at a separate display page.

In one embodiment of the present invention, the processor 102 may determine a position of a device 106 associated with the user, the username, or the user's network session, by tracking the device 106. For example, if the user logs into the network using a cell phone 106 having a unique phone number, the processor 102 may associate the session with the phone 106 having the unique phone number. The processor 102 may determine the location of the identified phone 106 via conventional tracking methods, e.g., via GPS signals, or in accordance with cells used by the cell phone 106.

### Map Updates

In one embodiment of the present invention, after the processor 102 transmits to a device 106 data for display of the map, the processor 102 may thereafter transmit data to the device 106 indicating updates to the map, such as those that are in response to changes in one or more users' locations, street changes, changes to buildings, etc., without retransmitting map data that had been previously transmitted to the device 106. For example, for each map data transmission to the device 106, the processor 102 may update a log stored in the memory 104 which indicates a time of the transmission. From the log, the processor 102 may determine which map data has been updated since the previous map data transmission to the device 106, and may selectively transmit to the device 106 data indicating the updates. The device 106 may be programmed for displaying the map by using previously received map data and updating it with the newly received map data. For example, during a first transmission of map data to the device 106, the processor 102 may transmit program code for execution at the device 106 providing the device 106 with the capability of using the received original data and the update data to display an up-to-date electronic map. The device 106 may locally store the program code.

In one embodiment, a log may be maintained for each network session. In an alternative embodiment, the log may be maintained for each device 106, regardless of session. For example, after a user logs into the network, the processor 102 may determine whether the device 106 had previously received map data in a previous session.

In one embodiment, the device 106 may store in a local memory a log of map updates.

During a network session, the device 106 may inform the processor 102 of a time of a last map data update, e.g., in response to a request for such information from the processor 102.

### Communication Between Network Users

In an embodiment of the present invention, a first user may communicate with a second user via the network. For example, the first user may transmit a communication to the server 100 with an instruction to transmit the communication to the second user. The first user may identify the second user, e.g., by providing the server 100 with the name or username of the second user. To do so, the first user may type in the name or username of the second user. Alternatively, the first user may select an object in the electronic map that corresponds to the username of the second user. The user may select the object, for example, via pressing keys of an input device 110, or by a point and click of a mouse 110.

If the second user is logged into the network, the server 100 may transmit the communication to the particular device associated with the second user's session, e.g., by dialing a phone number of the phone 106 associated with the session, or by addressing a computer terminal 106 associated with the session using a unique network address of the computer terminal 106. Alternatively, the server 100 may transmit the communication as an e-mail to an e-mail address of the second user. Alternatively, the server 100 may store the communication in a section of the memory 104 associated with and accessible by the second user. In one embodiment, if the second user is not logged into the network at the time of the communication, the server 100 may provide the content of the communication for later access by the second user, e.g., at a device 106 associated with the second user or at a memory location, such as in the memory 104, associated with the second user.

### Visual Representation of User Connectivity Status

In an embodiment of the present invention, the processor 102 may inform the first user of the network connectivity status of the second and other users by visually representing said status with reference to the electronic map. For example, the processor 102 may suppress from view objects that correspond to usernames that are not logged into the network. Accordingly, the presence in the map of a viewable object informs the first user that a username corresponding to the viewable object is logged into the network. It also informs the first user that an indicated location of a user with whom the username is associated is that which corresponds to the location in the map at which the object is placed. It will be appreciated that the suppression of objects corresponding to usernames that are not logged into the system is only one example embodiment of a manner by which to inform users of the connectivity status of other users, and that the information may be provided in other ways. For example, connected usernames may be displayed with full intensity, while non-connected usernames may be displayed having a faded appearance. Alternatively, and by way of example only, different colors or different object types may be used for a display of objects that correspond to connected usernames and non-connected usernames. For example, referring to FIG. 3, one pin is shown having a circle at the top, while another pin positioned at a lower portion of the map is shown having an ‘x’ at the top. The ‘x’ may indicate that the username corresponding to the object is not logged in.

In an embodiment of the present invention, the processor 102 may display the usernames corresponding to the objects displayed in the electronic map, e.g., at all times or in response to a selection by the first user of an object. For example, the first user may select the object by pointing with a mouse at the object. Alternatively, the user may select a location in the map and the processor 102 may display the usernames corresponding to all objects that are within a predetermined area dawn about the selected location. The predetermined area may be, e.g., in accordance with that which is instructed by a program being executed by the processor 102, or may be selected by the first user. In an alternative embodiment, the processor 102 may display the usernames corresponding to objects that are located in an area drawn about a location of the first user. It will be appreciated that just as usernames may be selectively displayed, the corresponding objects themselves may also be similarly selectively displayed.

### Filtered and Controlled Information Dissemination and Display

In an embodiment of the present invention, the first user may provide the processor 102 with a list of other users or usernames. The list may be stored in the memory 104. The processor 102 may selectively display objects corresponding to the users or usernames in the list, and may suppress from view objects corresponding to other users or usernames. In an embodiment of the present invention, the processor 102 may selectively display objects according to other filter parameters input by the first user. For example, the first user may indicate that the connectivity status of only those users or usernames located at particular location types, such as malls or museums; of only those users that have certain known characteristics, such as male/female; or of only those users that have certain known interests should be displayed. Such characteristics and interests may be provided by users to the server 100 for storage in the memory 104, for example, when registering with the network, and may be updated by the users during their network sessions. In one embodiment, the user may input filter parameters for the display of other object types too. For example, the user may request that for message posting objects, only those associated with a particular user, users, username, or usernames, or only those pertaining to a particular topic should be displayed. Additionally, the user may filter the display of objects by object type. For example, the user may instruct the processor 102 to display only structure objects, only user objects, only message posting objects, only street objects, only train objects, etc. For example, the user may instruct the processor 102 to display streets and suppress the subway paths, or vice versa.

In an embodiment of the present invention, the processor 102 may suppress objects in a map provided to a first user according to instructions provided by a second user with whom the objects are associated. For example, the second user may instruct the processor 102 to provide the second user's connectivity status and/or other information associated with the second user, such as posted messages, to only certain other users that do not include the first user, or may instruct the processor 102 not to provide the second user's connectivity status to the first user in particular.

In an embodiment of the present invention, a user may post messages to be viewed by all or particular other users. In response to such message postings, the processor 102 may embed an object corresponding to the posted message in the electronic map provided to the user and/or to the other users to whom the message is directed. The processor 102 may embed the object, e.g., at a map location associated with the posting user, or at a location associated with content of the message. For example, the message may discuss an event that takes place at a particular location. In one embodiment, the posting user may instruct the processor 102 to embed the object at a particular location. In one embodiment, the processor 102 may embed a particular object at different map locations for each of a plurality of users viewing the map. For example, one user may instruct the processor 102 to place all message posting objects at a location associated with the message poster, while another user may instruct the processor 102 to place all message posting objects at a location with which the message is associated. In one embodiment, the user may instruct the processor 102 to place the objects in both locations. In one embodiment, the user may instruct the processor 102 to place the object at a location according to an hierarchy of preferences. For example, the user may instruct the processor 102 to place the object at a location associated with the message if there is such a location, but to place the object at a location corresponding to the message poster if the message is not associated with a location.

### Providing a User with Information Regarding the User's Location

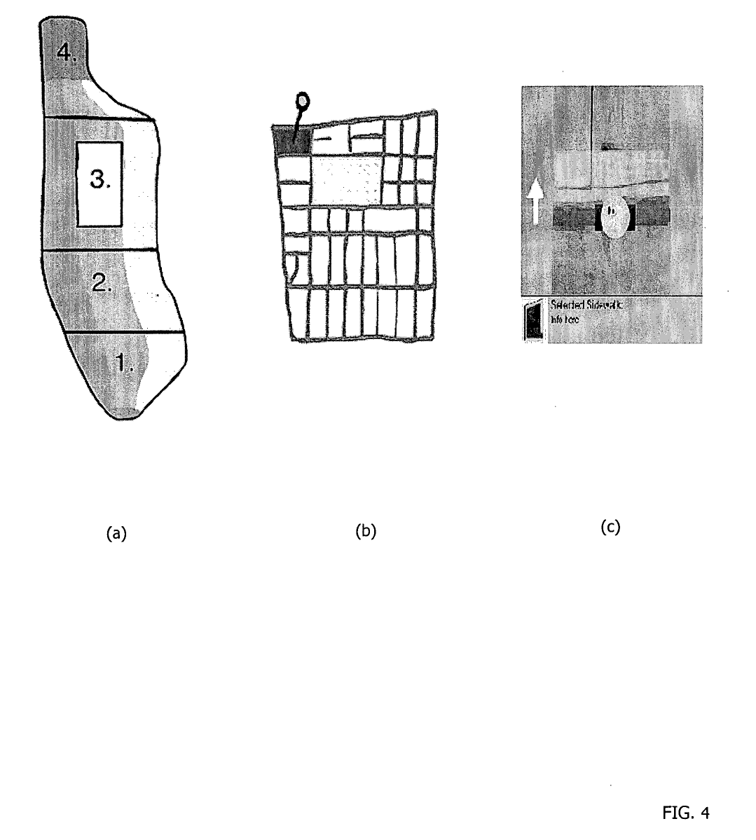

In an embodiment of the present invention, the processor 102 may provide a user with an ability to zoom in to focus on particular sections of the electronic map, and to zoom out again. FIG. 4 shows three maps. The first is a map of Manhattan. The second is a map of a particular section thereof. The third is a map of a particular section of a particular street or sidewalk in a section of Manhattan.

In an embodiment of the present invention, the processor 102 may transmit to a user, e.g., to a device 106 associated with the user, an interactive electronic map having embedded therein objects for display, including an object corresponding to the user. For example, the displayed object shown in the upper portion of part (c) of FIG. 4 may correspond to the user. The user may indicate to the processor 102 the real space location of the user. The processor 102 may place the corresponding object at a location in the map corresponding to the real space location. The user may transmit to the processor 102 updated real space location information, in response to which the processor 102 may display a gliding of the corresponding object along the sidewalk illustrated in the upper portion of part (c) in FIG. 4. Such location information may be input by the user as discussed above. For example, the user may transmit to the server 100 a picture of the sidewalk or a live video feed of the sidewalk. As the user moves and the unique pattern of the sidewalk of the video feed changes, the processor 102 may detect the user's movement by a change in the stored unique sidewalk pattern stored in the memory 104 to which the unique sidewalk pattern of the video feed is matched. In one embodiment, the user may select a region in a first map on which to focus. In response, a second map including only the selected region may be displayed as a main map, and the first map may be displayed as a secondary map. For example, in comparison to the first map, the second map may be displayed in a larger part of a display area allocated to the map display, as illustrated in part (c) of FIG. 4. As the object corresponding to the user is moved in the second map, a second object corresponding to the user may be displayed in the secondary map showing the user's movements with reference to the larger real space area covered by the secondary map.

As the object corresponding to the user is moved, the processor 102 may unsuppress all or particular objects embedded in a map area of a predetermined size drawn about the location at which the object corresponding to the user is located. The user may instruct the processor 102 to suppress particular object types or to unsuppress particular object types as discussed above. In one embodiment, where two maps are provided for simultaneous display, as illustrated in part (c) of FIG. 4, the processor 102 may unsuppress the objects in a map area of the main map, while suppressing objects, e.g., all objects or all objects but for the object corresponding to the user, in the secondary map.

### Location/Event Specific Program

It will be appreciated that the map content and the location information communicated between the user devices 106a-n and the server 100 may be transmitted in a variety of forms. For example, messages may be transmitted, e.g., as Short Message Service (SMS) or Multimedia Messaging Service (MMS) text messages, or as messages sent via a Flash based program. It will also be appreciated that not all processing must be performed by the processor 102 of the server 100. For example, some processing may be performed by a processor of a user device 106. For example, the server 100 may transmit to the user device 106 a program for execution by the processor of the user device 106 for generation of the electronic map discussed above. The processor 106 may communicate with the server 100 to obtain information stored in the memory 104 for generating and updating the electronic map. In addition, as indicated above, after a first transmission of map data by the processor 102 to the device 106, the device 106 may store the map data and may update a map display based on map data updates received from the processor 102, without receiving all of the map data each time the map is updated.

In an embodiment of the present invention, a method is provided for enhancing a location related experience by providing event and/or location specific interactive programs. Such event and/or location specific programs may be made available, e.g., at a location with which the program is associated, for example at a kiosk. Alternatively, it may be provided for download, e.g., using the Internet. The operability of such event and/or location specific programs may be made operable for a limited time, e.g., a day. Accordingly, if a user desires to use the program after the time has expired, the user may be required to re-obtain, e.g., purchase or download, the program.

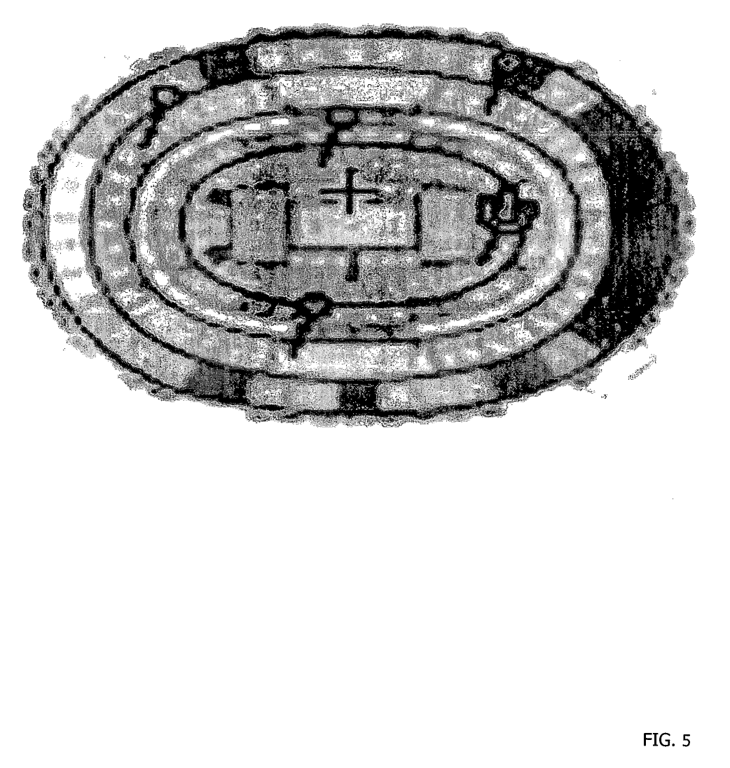

For example, programs for execution on a user device 106 for providing an interactive electronic map may be provided, e.g., sold to a user, for installation on the user device 106. A plurality of different programs may provided, each program providing unique functionality and/or object types and/or objects for display in an electronic map generated by the program. The programs may be uniquely tailored for interacting with objects associated with particular events and/or locations. For example, in one embodiment, a program may be provided for enhancing an experience of a user attending an event, e.g., a baseball game. The map generated by the program may be of the ballpark or stadium at which the baseball game is played, for example, as illustrated in FIG. 5. Objects may include those that represent concession stands, e.g., at which the user may place an order by communicating with an operator of the concession stand. The user may initiate such communication by selecting the object representing the concession stand. Objects may also include those that relate to a seating plan at the ballpark or stadium. For example, there may be provided for each seat in the ballpark or stadium a corresponding object. Objects may also include those that represent other users attending the game. For example, a central server 100 may be provided for all available programs. Alternatively, for each available program, a separate corresponding server may be provided. At the central server 100, for example, the memory 104 may be updated to indicate that a user has logged into the network using a particular program. The objects corresponding to users who have logged into the network using a particular program may be made available to other users who have logged into the network using the same particular program. Objects may include those which correspond to real objects and structures at the facility at which the event is held. For example, an object may represent a screen at the ballpark. A quiz question may be displayed on the screen. It may be indicated that a user who correctly answers the question receives a prize. The user may select the object in the map corresponding to the screen for initiating a communication in which the user may answer the question.

In one embodiment of the present invention, the programs installed on the user device 106 may include code for generating the map display including at least some map objects, e.g., without receiving map data from the server 100. The device 106 may communicate with the server 100 to obtain updates to the map, as discussed above. In one embodiment, transmission of map data for generating objects corresponding to certain basic structures, e.g., of a location corresponding to the installed program, such as data representing a stadium, its vendors, etc., may be omitted. Generation of such objects may be instead performed based on code of the installed program. The program may receive from the server 100 map data for generating map objects corresponding to real objects and structures that are subject to more frequent change, e.g., message postings and user objects. New program versions may be coded when changes are made to the more stable objects.

Said programs need not be associated with a particular event, but may be instead associated with a particular location, e.g., a mall. For example, the program may provide a map with objects for each store in the mall. A user may, for example, select an object corresponding to a particular store for placing an order. In addition, if a first user indicates that the first user is located at a particular store at the mall, the program may display an object corresponding to the user at a location in the map corresponding to the store. A second user may select the object corresponding to the first user to establish communication with the first user, for example, to inquire about the first user's opinion of the store and/or items sold therein. In addition, in one embodiment, a user may post messages at locations in the map corresponding to particular stores inquiring about certain items, for example. Another user who has recently visited the store may select the message for establishing communication with the message poster in order to reply to the inquiry.

In an embodiment of the present invention, objects corresponding to all users of a same event and/or location specific program may be embedded in the map and displayed for view by users of the program. A particular user may instruct the program to suppress from view objects corresponding to particular users, or may instruct the program to display only user objects corresponding to particular users.

In an embodiment of the present invention, a plurality of the event and/or location specific programs may be provided. Each program may be for interaction with, and may correspond to, a particular event and/or location. A central server 100 may be provided for a general computer networking system. The user devices 106, when executing the event and/or location specific programs, may connect to and communicate with the central server 100, thereby using resources of the general computer networking system. For example, a particular user of the general computer networking system may transmit to the server 100 a list of network users, the connectivity status of whom the particular user desires to be informed. When the particular user logs into the network via an event and/or location specific program, the particular user may be informed of the connectivity of listed network users who are logged into the network using the same event and/or location specific program used by the particular user. Alternatively, or as an additional option, the particular user may be informed of the connectivity of listed network users who are logged into the network and are located at the location to which the event and/or location specific program relates, whether or not the listed network users are logged into the network via the same event and/or location specific program. Alternatively, or as an additional option, the particular user may be informed of the connectivity of all network users, even those not included in a list provided by the particular user, who are located at the location to which the event and/or location specific program relates, and, in one embodiment, who are logged into the network using the same event and/or location specific program used by the particular user. For communicating the connectivity status of said users, objects may be provided in a map for viewing at the particular user's device 106.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method, comprising:
with reference to a map, visually communicating to a first network user a connection status of a second network user.

2. The method of claim 1, wherein the visual communication includes displaying an object representing the second user at a location in the map associated with the second user.

3. The method of claim 2, further comprising:
receiving from the second user data indicating a location,
wherein the location in the map corresponds to the indicated location.

4. The method of claim 3, wherein the indicated location is at least one of a residence, a current position, and an intended destination of the second user.

5. The method of claim 3, wherein the data represents an image of the indicated location, further comprising:
storing data corresponding to a plurality of images;
associating each of the images to a corresponding location in the map;
matching the image represented by the received data to one of the plurality of images;
determining which location in the map corresponds to the one of the plurality of images; and
determining the location in the map associated with the second user to be the location that corresponds to the one of the plurality of images.

6. The method of claim 2, wherein the object is displayed upon a condition that the second user is connected to the network.

7. The method of claim 2, wherein the object is displayed in a first manner if the second user is connected to the network and in a second manner if the second user is disconnected from the network.

8. The method of claim 1, further comprising:
receiving from the first user a list of other users,
wherein the connection status of the second user is communicated to the first user upon a condition that the second user is identified in the list.

9. The method of claim 1, further comprising:
receiving from the second user disclosure instructions,
wherein the connection status of the second user is communicated to the first user upon a condition that the disclosure instructions do not prohibit disclosure to the first user of the connection status of the second user.

10. The method of claim 2, further comprising:
detecting a location of a device registered to the second user,
wherein the location in the map corresponds to the detected location.

11. The method of claim 10, wherein the device is one of a cell phone, a pager, a telephone, a computer terminal, a pocket PC, a tablet PC, a laptop, a Global Positioning System (GPS) device, and a data transceiver device.

12. The method of claim 2, further comprising:
in response to a selection by the first user of the object, contacting a device associated with the second user, the device being contacted for establishing a communications session between the first and second user.

13. The method of claim 2, wherein the object includes an identification of the second user, further comprising:
displaying data associated with the second user in response to a selection of the object.

14. The method of claim 13, wherein the selection includes an input for at least one of moving a cursor to the location, moving a pointer to the location, and clicking the location.

15. A computer-readable medium having stored thereon instructions adapted to be executed by a processor, the instructions which, when executed, cause the processor to perform the method of claim 1.

16. A method, comprising:
storing an electronic map having embedded therein objects of a plurality of object types;
retrieving the stored electronic map;
for at least one of the object types, determining in accordance with a display mode whether to suppress objects of the object type from being displayed in a display of the electronic map; and
displaying the electronic map in accordance with the determination.

17. The method of claim 16, further comprising:
receiving data indicating a user selection of at least one of (a) a first subset of the plurality of object types, objects of the first subset to be displayed, and (b) a second subset of the plurality of object types, objects of the second subset to be suppressed from display,
wherein the display mode is set in accordance with the received data.

18. The method of claim 16, wherein the plurality of object types include at least one of a user object type, a broadcast object type, an event object type, a structure object type, a facility object type, and a pathway object type.

19. The method of claim 18, wherein the pathway object type includes at least one of a street object, a subway object, a waterway object, a bicycle path object, a bridge object, and a tunnel object.

20. The method of claim 18, further comprising:
displaying an object representing a network user at a location in the map associated with the network user,
wherein the object representing the network user is displayed upon a condition that the network user is connected to the network.

21. The method of claim 18, further comprising:
receiving a first user input location data indicating a first location of a user;
displaying an object representing the user at a first location in the map corresponding to the first location of the user;
receiving a second user input location data indicating a second location of the user;
modifying the display of the object representing the user so that it is displayed at a second location in the map corresponding to the second location of the user.

22. The method of claim 21, further comprising:
for each update to the display of the object representing the user, at least one of:
(a) for a particular object type:
determining if an area of a predetermined size drawn about a location in the map at which is displayed the object representing the user includes a suppressed object of the object type; and if so
unsuppressing the suppressed object; and
(b) determining if a stored data includes non-displayed data that is associated with the area; and if so
displaying the non-displayed data.

23. The method of claim 21, wherein the first user input location data represents an image of the first location.

24. The method of claim 21, wherein the second user input location data is input via at least one of a scroll of a scroller, and a selection of a direction key.

25. The method of claim 18, further comprising:
receiving a broadcast message from a user, the broadcast message associated with a particular location; and
in response to the received broadcast message, embedding in the map a broadcast object associated with the broadcast message at a location corresponding to the particular location,
wherein the broadcast object is viewable by a plurality of users.

26. The method of claim 25, further comprising:
continuously updating the displayed map to reflect changes to the embedded objects.

27. A method comprising:
providing a first copy of at least one of (a) a location-specific program and (b) an event-specific program for execution at a user device, the program, when executed, providing a map of a location to which the program relates, the map having embedded therein a selectable interactive object for establishing a communication with another device via a network.

28. The method of claim 27, wherein the program, when executed, inserts a new selectable object in response to an object-posting instruction input by a user.

29. The method of claim 27, wherein the program, when executed, establishes a communication between a user of the first copy of the program and a user of a second copy of the program in response to a selection by the user of the first copy of an object associated with the user of the second copy.

30. The method of claim 27, wherein at least one of:
a plurality of location-specific programs is provided, each program being associated with a particular one of a plurality of locations; and
a plurality of event-specific programs is provided, each program being associated with a particular one of a plurality of corresponding events.

31. A computer network, comprising:
a processor; and
a user device having a display, the processor generating a map having embedded therein objects for visually communicating to a first user a connection status of a second user, the map being laid out in the display.

32. A computer-readable medium having stored thereon instructions adapted to be executed by a processor, the instructions which, when executed, cause the processor to perform a method, the method comprising:
providing for display a map having embedded therein a plurality of objects including at least one selectable object for interaction via a network by a user with a device to which the object corresponds, wherein the plurality of objects is at leas one of location specific and event specific.

33. A method, comprising:
with reference to a displayed map, receiving by a first network user a visual communication of a connection status of a second network user.
